(19) United States
(12) Patent Application Publication
(10) Pub. No.: US 2013/0091409 A1
(43) Pub. Date: Apr. 11, 2013

(54) METHOD AND SYSTEM FOR DYNAMIC ASSEMBLY OF MULTIMEDIA PRESENTATION THREADS

(71) Applicant: Mark John Jeffery, Mesa, AZ (US)

(72) Inventor: Mark John Jeffery, Mesa, AZ (US)

(73) Assignee: AGILE INSIGHTS, LLC, Mesa, AZ (US)

(21) Appl. No.: 13/269,534

(22) Filed: Oct. 7, 2011

(51) Int. Cl. G06F 17/00; G06F 15/16

(52) U.S. Cl. 715/202

(57) ABSTRACT

The present invention involves a technique for the customization and display of multimedia content. Customization is via a dynamic thread generator that receives data from multiple inputs including, but not limited to, user surveys, demographic databases, analytics of past customer behavior and preferences stored in a customer relationship management system, analytics of customer interaction with the media in the tool, and/or interaction of the user with sensors /measurement devices. The dynamic thread generator produces a plurality of thread nodes which can be traversed in a particular order, forming a presentation thread, customized to a specific user.

### FIELD OF THE INVENTION

The present invention relates to a method and system for dynamic assembly of multimedia presentation threads.

### BACKGROUND

Conventional media, such as books or video, typically are single threaded. That is, the user navigates through a book from “Chapter 1” to “Chapter 2”, and so on, or watches a video presentation linearly, often from the starting point. Although the reader of a book may vary the journey and jump to a particular content area, guided by the table of contents or the index, the user follows the original thread, just from a different starting point.

With the introduction of electronic books (e-books), users have been able to create their own customized works. Using an e-book compiler, one can compile a customized e-book by combining selected text documents from multiple sources to create a series of chapters. However readers still experience the e-book identically to a conventional book, and there is no customization within specific chapters of the e-book.

Over the years, various attempts have been made to provide information in a more customized fashion. For example, there are prior art sales tools that provide information based upon an initial survey. Some of these software tools even provide content in various formats, so that different media (video, white papers or power point slides) are presented based upon the survey data collected. Users travel on distinct paths accessing different content, based upon their survey responses. However, a notable limitation of these prior art sales tools is that customization is based singularly upon the initial survey input, and each thread is independent, with different distinct endpoints and no intersections.

### SUMMARY OF THE INVENTION

The present invention involves a technique for the customization and display of multimedia content. Customization is via a dynamic thread generator that receives data from multiple inputs including, but not limited to, user surveys, demographic databases, analytics of past customer behavior and preferences stored in a customer relationship management system, analytics of customer interaction with the media in the tool, and/or interaction of the user with sensors/measurement devices. A user thread is a specific path consisting of nodes, which are collections of customized multimedia content. The dynamic thread generator produces a plurality of thread nodes, which can be traversed in a particular order, such that the each node's multimedia content and the thread path are customized to the particular user.

A notable feature of the present invention is that the customization of content changes dynamically as the user traverses a presentation thread and interacts with the system. Furthermore several content elements, such as an animated simulation and multiple video clips, may be assembled from a content database and displayed simultaneously at each thread node. In an embodiment, a presentation snippet can include different content output on multiple and discretely different devices connected simultaneously via a wireless, cell phone or computer network.

The assembled presentation threads can be used for various purposes, such as, for example, to construct tailored sales presentations directed to various different personnel within an organization, present information on how to use a product or service, select a product or service, explain how to learn to play a sport (such as golf, tennis or baseball), and learn a complex subject such as marketing or technology management.

Preferably, the assembled presentation threads are presented via a mobile device such as a tablet computer or a smart phone, and the set of inputs includes those entered by the user via a touch screen in response to one or more question, and/or via interaction with sensors. The multimedia threads may also be presented via an Internet web page or a Web-enabled television, and/or on multiple such display devices simultaneously.

These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 illustrates an exemplary system for dynamic assembly of presentation threads, according to an embodiment of the present invention;

FIG. 2 illustrates a block diagram showing the architecture of a device useable in conjunction with the present invention;

FIG. 3 illustrates an exemplary system for dynamic assembly of presentation threads in a Web-based environment, according to another embodiment of the present invention; and

FIGS. 4 to 11 show exemplary screen layouts illustrating a sales tool implemented using techniques described herein, according to an embodiment of the present invention.

### DETAILED DESCRIPTION

For clarity and consistency, the following definitions are provided for use herein:

Presentation snippet: A component of a multimedia presentation, such a video clip, an animation, a survey, text, an audio recording, a hologram and/or any other media content, or a combination thereof

Thread node: A node of a presentation thread representing a presentation snippet.

Presentation Thread: The sequence of thread nodes comprising customized multi-media content for a particular user.

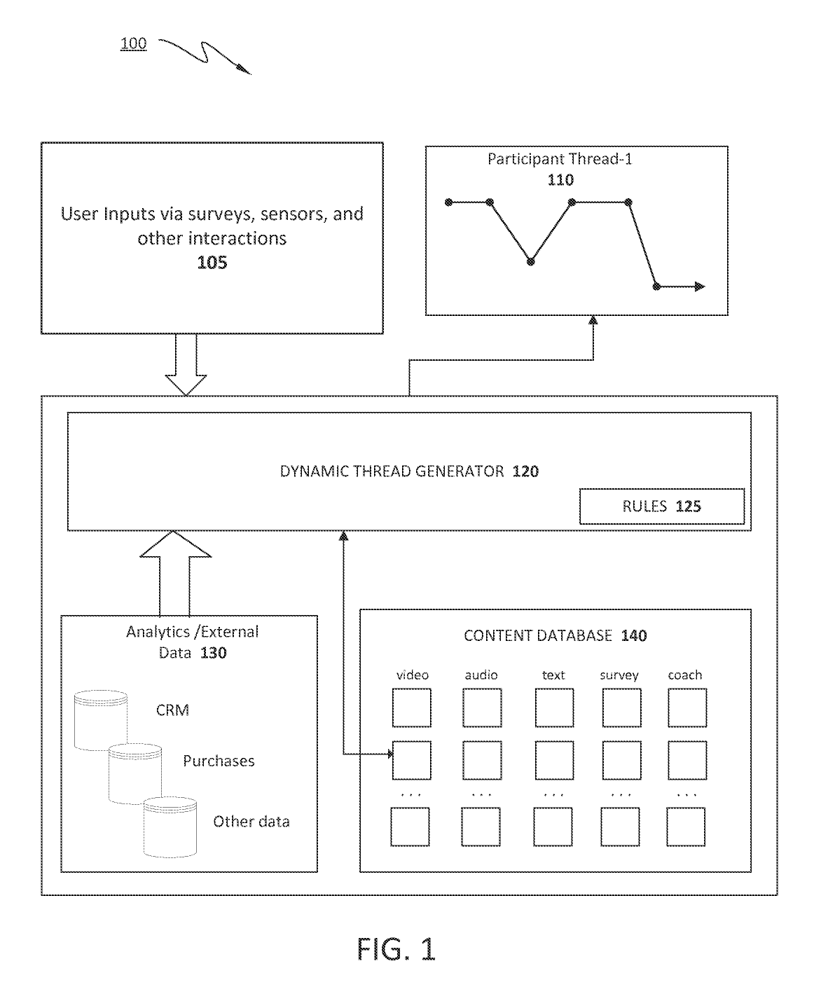

Referring to FIG. 1, an exemplary system for dynamic assembly of presentation threads 100 is illustrated. The system for dynamic assembly of presentation threads 100 includes a dynamic thread generator 120 that, responsive to a set of user inputs 105 and/or analytics/external data 130 (e.g., demographic information, customer behavior/preference information), applies a set of rules 125 to generate each of a plurality of thread nodes which can be traversed in an order, forming a presentation thread 110.

The generated presentation thread 110 can include customized information, thereby creating a multimedia presentation tailored to a particular user. The dynamic thread generator 120 can be a standalone application stored in, and executed using, a single computing device or implemented on one or more servers accessible by one or more client devices. In an embodiment, the dynamic thread generator 120 is configured to generate a plurality of presentation threads 110, each for one of a plurality of users.

As the user traverses the presentation thread 110, the dynamic thread generator 120 generates the next thread nodes of the presentation thread 110. At each thread node, at least one presentation snippet, assembled using content from a content database 140, is outputted to the user. The content database 140 can include any organized collection of media files (e.g., text files, audio files, video files). In an embodiment, a plurality of content elements, such as animated simulations and multiple video clips may be assembled into a presentation snippet, and displayed simultaneously, or in sequence. In an embodiment, the selection, assembly, and ordering depend on the set of rules 125 as well as the capabilities of the user device. In an embodiment, the dynamic thread generator 120 assembles each presentation snippet from content elements selected from the content database 140 “on the fly” as the user traverses the presentation thread 110. However, in other embodiments, the presentation snippets are pre-assembled, and the pre-assembled presentation snippets are selected from the content database (e.g., as HTML files). Preferably, the rules 125 are maintained in a separate module, file, or database and can be modified by changing (or replacing) the module, file, or database fields without requiring any change to another component. However, in an embodiment, the rules 125 can be “hard coded” within the application logic.

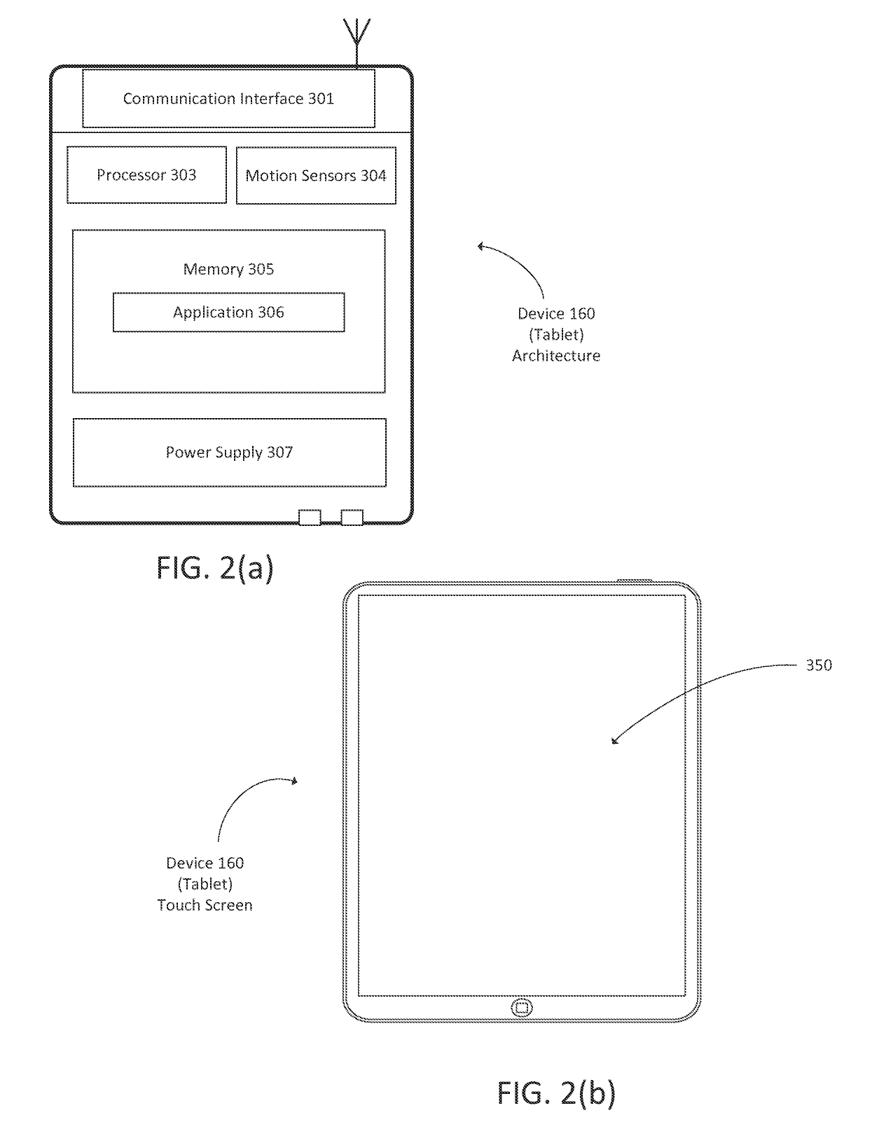

Referring to FIGS. 2(a) and 2(b), an exemplary device 160 useable in conjunction with the embodiment of FIG. 1 is illustrated. For illustrative purposes only, the following discussion describes the device 160 in terms of an Apple iPad available at the time of filing. However, it is to be understood that much of the discussion is applicable to other tablet computers (e.g., Samsung Galaxy Tab, HP TouchPad, Toshiba Thrive, and Lenova IdeaPad K1), as well as other devices with computing capabilities, such as, but not limited to, various smart phones, laptop computers, desktop computers, etc., existing today or later developed. Furthermore, it is to be understood that over time, device capabilities will increase. Indeed, under Moore's Law, the number of transistors that can be placed on an integrated circuit has doubled approximately every eighteen months and this trend is expected to continue for the foreseeable future. Accordingly, it is to be understood that the device 160 chosen herein for discussion purposes is merely meant to provide an example as to how the present invention may be implemented at the current time.

As shown in FIG. 2(a), the exemplary device 160 includes a communication interface 301, a processor 303, motion sensors 304, a memory 305, and a power supply 307. The communication interface 301 controls various input/output devices including a digital camera, a 30-pin dock connector port, a 3.5-mm stereo headphone jack, and a built-in speaker and microphone. The communication interface 301 also includes a touchscreen 306 (shown in FIG. 2(b)) that includes a 9.7-inch (diagonal) LED-backlit glossy widescreen Multi-Touch display having a 1024-by-768-pixel resolution at 132 pixels per inch (ppi). The processor 303 is an Apple A4 processor which has a system-on-a-chip (SOC) architecture that integrates the main processor, graphics silicon, and other functions such as a memory controller. The Apple A4 is based on a 32-bit reduced instruction set computer (RISC) instruction set architecture (ISA) developed by ARM Holdings, known as “ARM” or “Advanced RISC Machine”. The motion sensors 304 can include a three-axis gyro to measure a rate of rotation around a particular axis, an accelerometer to measure acceleration in three axes, an ambient light-sensor, a digital compass, and a global positioning system (GPS) device. The memory 305 includes 16 GB, 32 GB, or 64 GB of flash memory (depending on the model). The memory 305 includes storage for an application 306 (“app”) which includes the software of the invention. The power supply 307 includes a 25-watt-hour rechargeable lithium-polymer battery and power charger.

The techniques of the present invention described herein (e.g., use of the dynamic thread generator 120 to generate a presentation thread 110) can be accomplished by loading an appropriate application 306 into the memory 305 and executing the application 306. Where the device 160 is the Apple iPad, the user inputs 105 can be received via the touchscreen 306 and the generated presentation thread 110 can be presented to the user by way of the same touchscreen 306 (and speakers), for example. An application 306 for the Apple iPad can be developed using the Apple Developer Suite, including use of Xcode, Interface Builder, and iPhone Simulator development tools, or via custom programming in Objective C. Furthermore, the Apple “Media Player” framework can be used to provide media playback capabilities for the iPad. Apple supports at least the following codecs: H.264 Baseline Profile 3, MPEG-4 Part 2 video in .mov, .m4v, .mpv, or .mp4 containers, as well as AAAC-LC and MP3 formats (for audio). The content database 140 described herein can include a folder (or set of folders) including a collection of media files in supported formats. The media files can exist in the memory 305 or an external server addressable by a URL, for example. For further information regarding programming for the Apple iPad, see, Sams Teach Yourself iPad Application Development in 24 Hours, by John Ray, Sams (Pearson Education, Inc.), 2011, ISBN 978-0-672-33339-2, which is incorporated herein by reference in its entirety. It is to be understood that where the device 160 is other than the Apple iPad, other programming techniques and tools can be used. For example, where the device 160 is a mobile device such as a smartphone or tablet computer utilizing the Android operating system, an appropriate Android software development kit (SDK) can be used to provide the tools and application program interfaces (API) for developing the application 306 on the Android platform using the Java programming language.

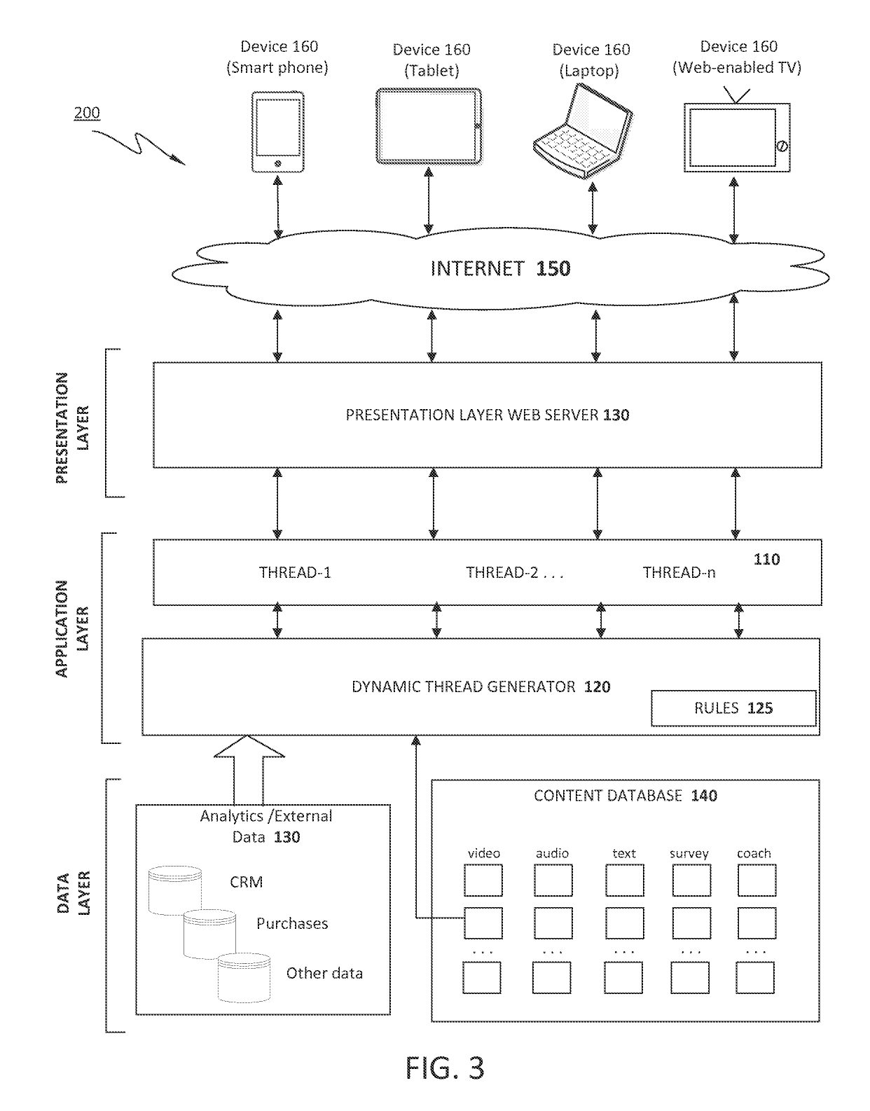

FIG. 3 illustrates an exemplary system for dynamic assembly of presentation threads 200, according to another embodiment of the present invention. As shown, several different client devices 160 (e.g., a smart phone, a tablet computer, a laptop computer, and a Web-enabled television) are coupled to the Internet 150. While several user devices are shown in FIG. 3, it is to be understood that many more concurrent users and devices may be supported. Initially, a device 160 connects to a Web site by the user linking to a URL in a browser. Then, at a presentation layer web server 130, device information is determined to identify the type of device and browser being used. This may be done in various known ways, such as, for example by obtaining the user-agent string passed by the browser of the device 160 which indicates which browser is being used, its version number, and the operating system and version. The device information is then used to ensure that the presentation snippets created are compliant with the device 160. For example, where the device 160 is a desktop computer with Internet Explorer, the presentation snippets may use Adobe Flash media, but if the device 160 is an Apple iPhone with the Safari browser, an alternative format would be chosen. Likewise, the presentation layer web server 130 may determine that a mobile browser will be used. In that case, the web pages outputted to the device 160 may contain information that is easier to view on a smaller screen having a lower resolution. In an embodiment, the presentation snippets include code for display via an HTML 5 enabled web browser. HTML 5 allows rich multimedia content display on multiple platforms with features designed to make it easy to handle multimedia content without to resort to proprietary APIs and plugins.

Additionally, a user-ID can be used to track the user. For existing clients, the user-ID can be provided by the user through an authentication process upon user log-in. New users can be assigned a unique user-ID and select a password, for example. Furthermore, a thread-ID can be assigned for the particular session for the generated presentation thread 110. Other user information (e.g., demographics, purchase history, preferences) may also be obtained from various sources, e.g., the analytics/external databases 130. In certain cases, the user might be a sales lead with whom a sales associate has already been working or an existing customer who desires information as to another product or service. The device 160 could be a tablet computer provided by a sales associate during a sales presentation, for example. As the user traverses the presentation thread 110, the dynamic thread generator 120 keeps track of the user's position (current thread node), and generates/selects a presentation snippet associated with the current thread node for display on the user's device 160, where it is presented to the user. User inputs (e.g., responses to a survey) are sent from the device 160 back to the dynamic thread generator 120.

It is to be understood that the dynamic thread generator 120 includes a computer system and software of the invention stored in memory. In the embodiment illustrated in FIG. 3, the computer system can include a central processor, memory (RAM, ROM, etc.), fixed and removable code storage devices (hard drive, floppy drive, CD, DVD, memory stick, etc.), input/output devices (keyboards, display monitors, pointing devices, printers, etc.), and communication devices (Ethernet cards, WiFi cards, modems, etc.). Typical requirements for the computer system include at least one server with at least an INTEL PENTIUM III processor; at least 1 GB RAM; 50 MB available disc space; and a suitable operating system installed, such as LINUX, or WINDOWS 2000, XP, Vista, Windows 7 or 8 by Microsoft Corporation. Representative hardware that may be used in conjunction with the software of the present invention includes the POWER EDGE line of servers by Dell, Inc., the SYSTEM X enterprise servers by IBM, Inc., PROLIANT or INTEGRITY line of servers by Hewlett-Packard, and the SPARC line of servers by Oracle Corporation (formerly Sun Microsystems). The software to accomplish the methods described herein may be stored on a non-transitory, computer-readable medium and may also be transmitted as an information signal, such as for download. The content database 104 can include any computer data storage system, but, preferably, is a relational database organized into logically-related records. Preferably, the content database 140 is an enhanced relational database such as the IBM DB2 Universal Database using IBM's Audio, Image, and Video (AIV) Extenders, to support various media files, or the Oracle InterMedia product which enables an Oracle database to store, manage, and retrieve images, audio, video, in an integrated fashion.

It is to be understood that although not illustrated, the analytics/external data 130 can be accessed from external sources each of which have their own computers with central processors, memory (RAM, ROM, etc.), fixed and removable code storage devices (hard drive, floppy drive, CD, DVD, memory stick, etc.), input/output devices (keyboards, display monitors, pointing devices, printers, etc.), and communication devices (Ethernet cards, WiFi cards, modems, etc.). Alternatively, the analytics/external data 130 and the content database 140 can be implemented on the same physical computer system.

Although the Internet 150 is depicted as being used for communication among the illustrated entities, it is to be understood that other network elements could, alternatively, or in addition, be used. These include any combination of wide area networks, local area networks, public switched telephone networks, wireless or wired networks, intranets, or any other distributed processing network or system.

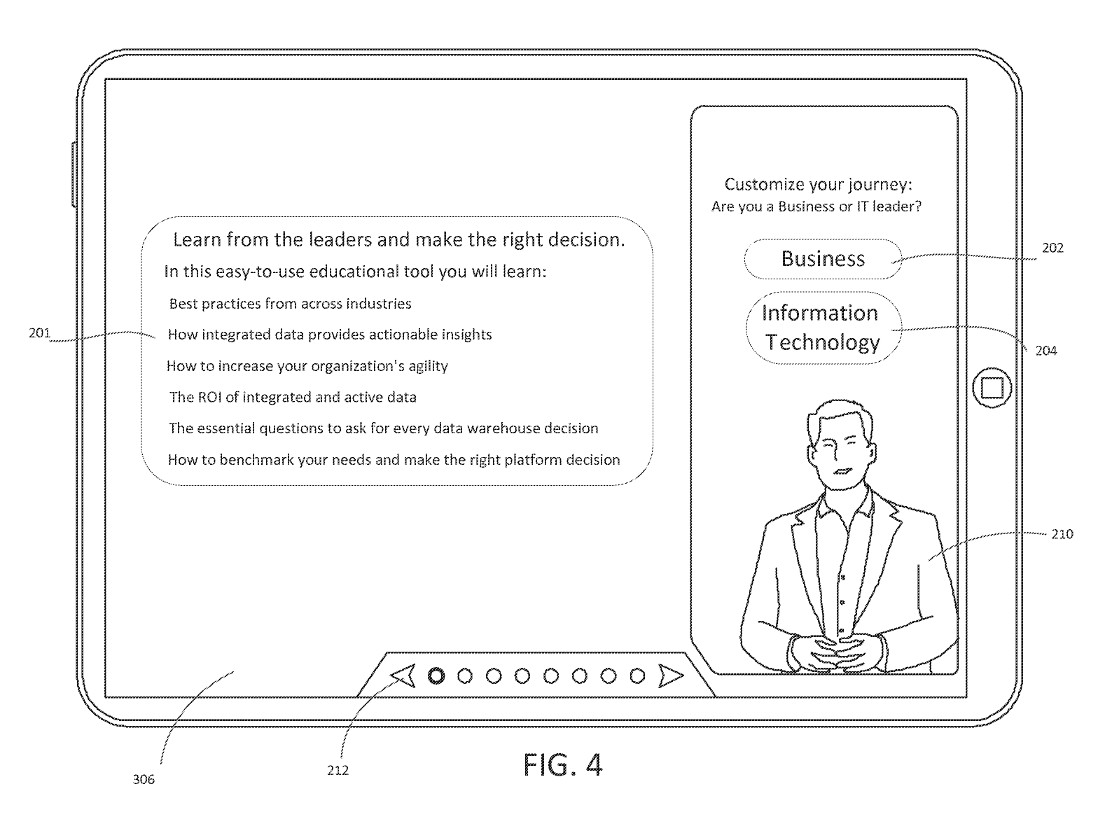

Referring to FIGS. 4-11, the present invention will be further clarified by the following example of a sales tool implemented using techniques described herein, according to an embodiment of the present invention. In this example, the sales tool is useful for persuading various people within an organization as to the benefits of a data warehouse product.

FIG. 4 shows the first node of the presentation thread 110 where several media components are assembled into a presentation snippet. In this example, the presentation snippet includes introductory text 201 presented in the left portion of the touchscreen 306 while video of a coach 210 is presented on the lower-right side of the touchscreen 306. In the video recording, the coach 210 invites the user to select their main “role” within the organization, i.e., either “Business” 202 or “Information Technology” 204. The sales presentation may further query for a more specific role or responsibility within the organization, but here the elemental survey input serves to differentiate “business” from “technical” users.

When the user touches either “Business” 202 or “Information Technology” 204, the input is used to determine the next node in the presentation thread 110. Depending on the selection, the user will traverse different presentation threads 110. However, even though these presentation threads 110 are separate and distinct, there are points where the presentation threads 110 intersect; that is there are presentation snippets which are common to all users. Furthermore, the user may “go back” to the prior presentation snippet by touching the left arrow 212 (at the bottom of the screen). If the user responds differently than he or she did previously when at the prior node (e.g., this time selects “Business” 202 instead of “Information Technology” 204) then the user will traverse a different path through the presentation thread 110. (Of course, the user would not be able to “go back” from the first node since there is nothing prior to this).

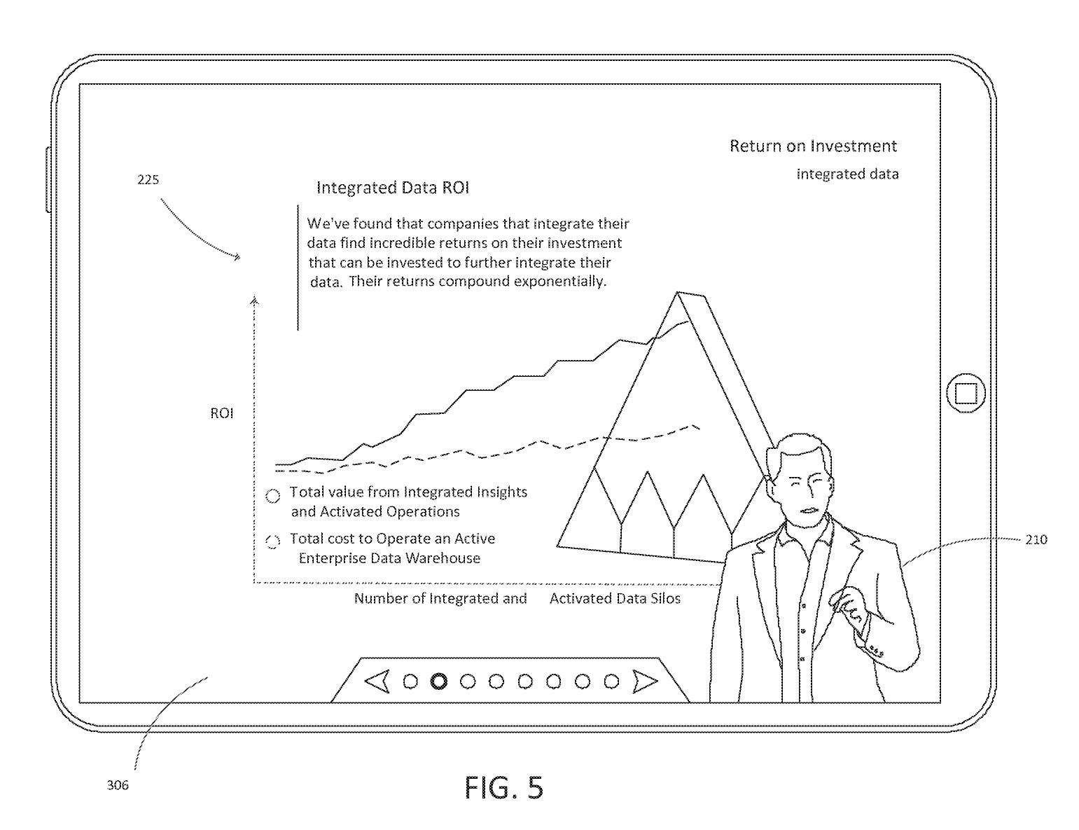

FIG. 5 shows a later node in the presentation thread 110, wherein both “business” and “technical” users see the same core simulation 225; however the text on the simulation is customized to the respective users, and the dialogue of the coach 210 is different for respective users. Specifically, business users hear how integrating data drives value by creating agility, where technical users hear that value is created from the reduced costs of personnel for the integrated systems.

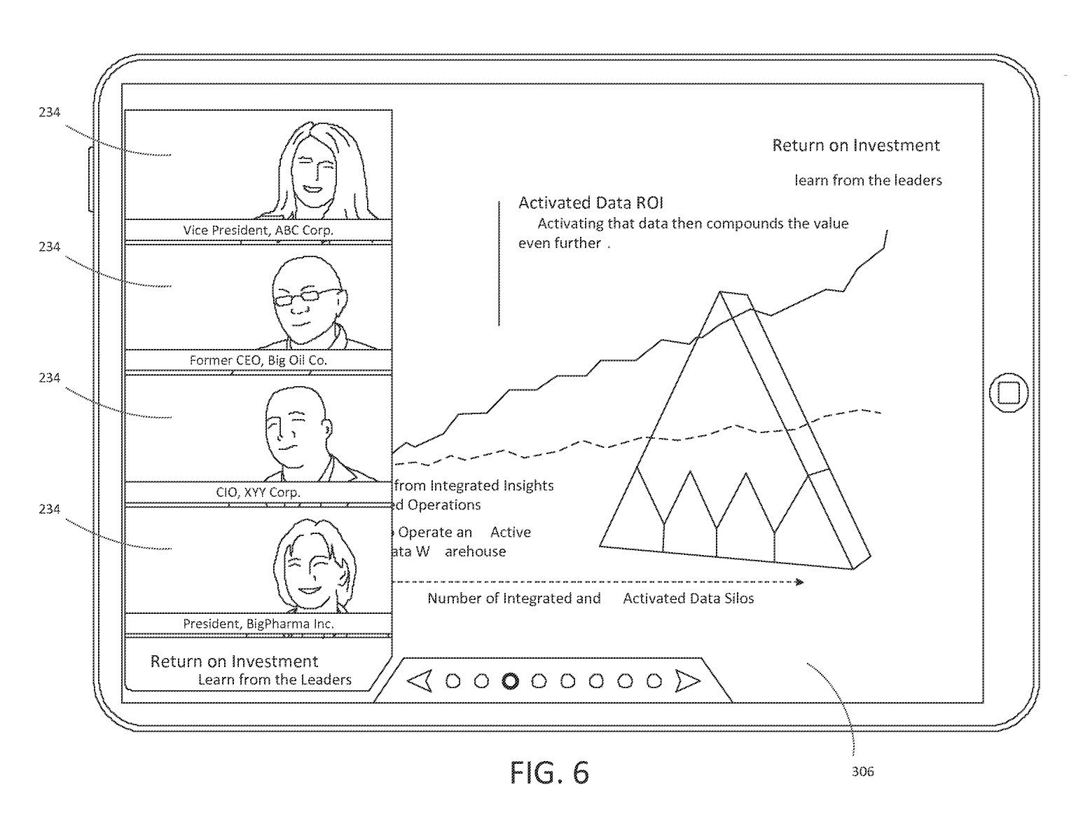

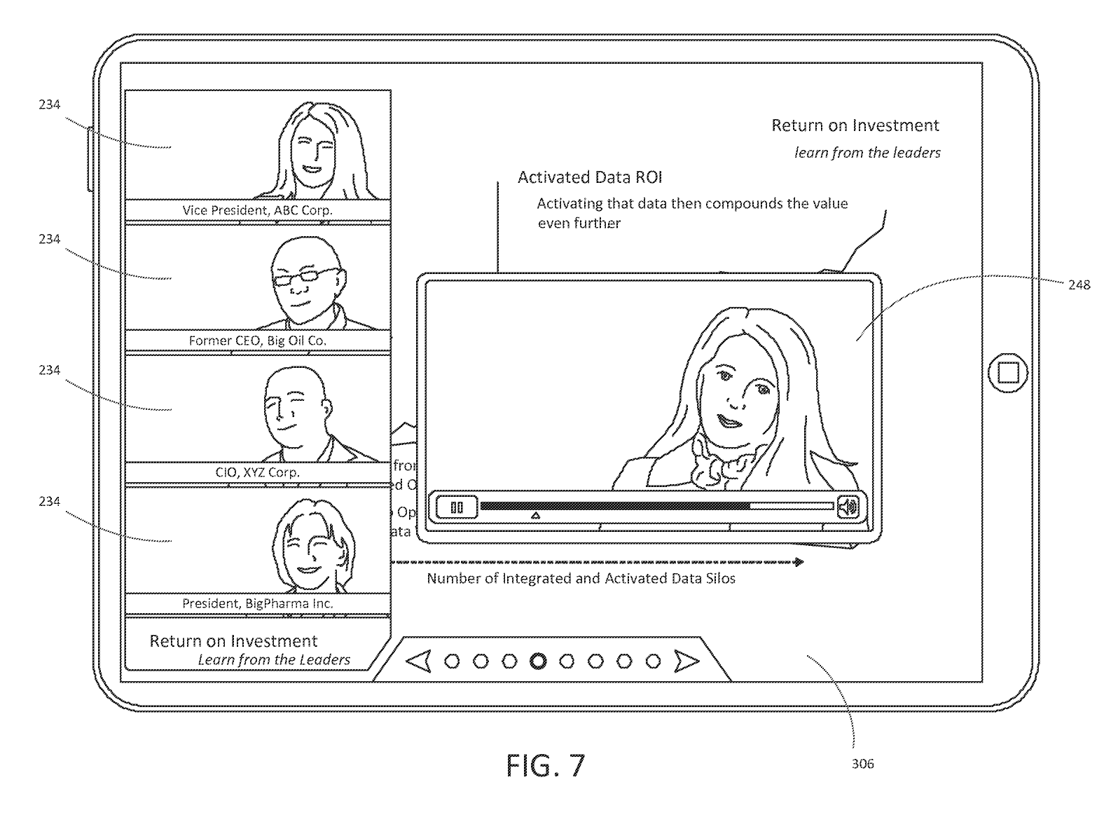

FIG. 6 shows video snippets 234 overlaid on the touchscreen 306. Different video snippets 234 are dynamically retrieved from the content database 140 and are customized for different users. For example, business executives may see testimonials from chief executive officers and other senior business leaders, IT leaders see discussions from chief information officers, technical managers see discussions from database administrators, and so forth. The user touches the touchscreen 306 to select/play a selected video snippet 248 (See FIG. 7). This interaction can be logged and analytics used to further refine future content displayed in a user's thread. For example, if a preference is observed for the user selecting accounting content presented by female executives then, at future thread nodes, the dynamic thread generator 120 may serve additional video snippets of female executives discussing accounting issues.

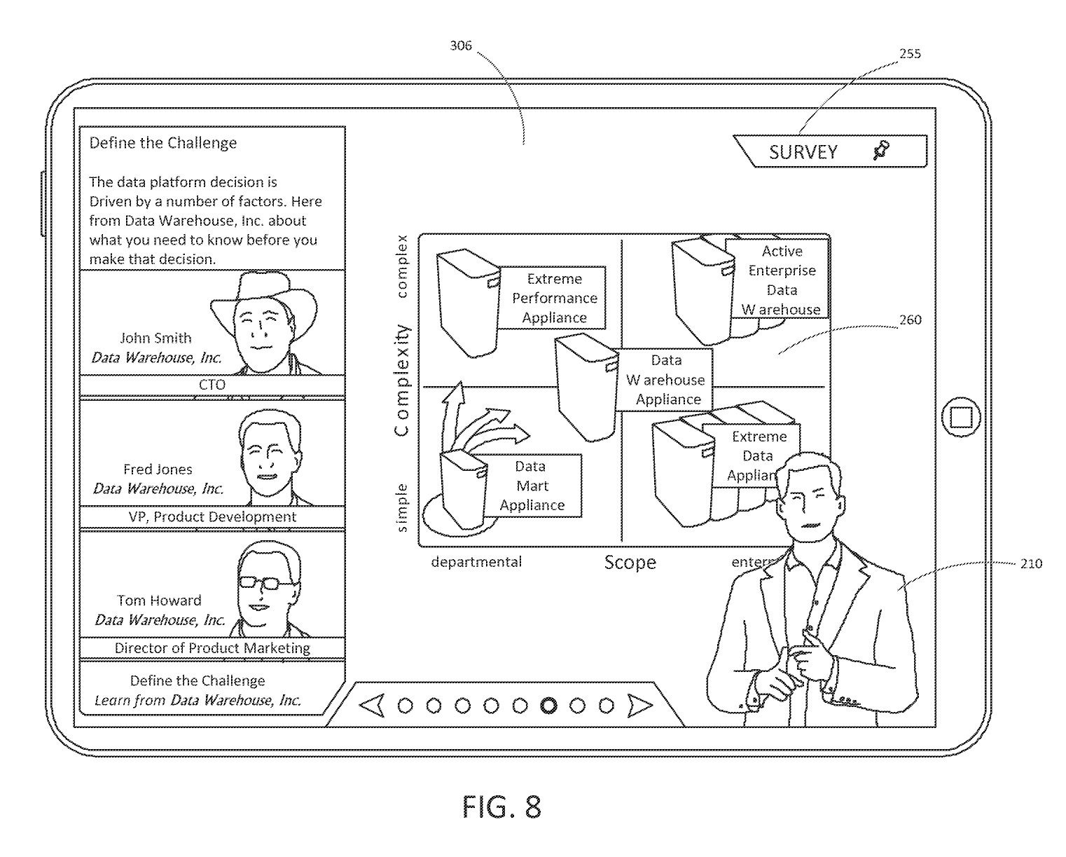

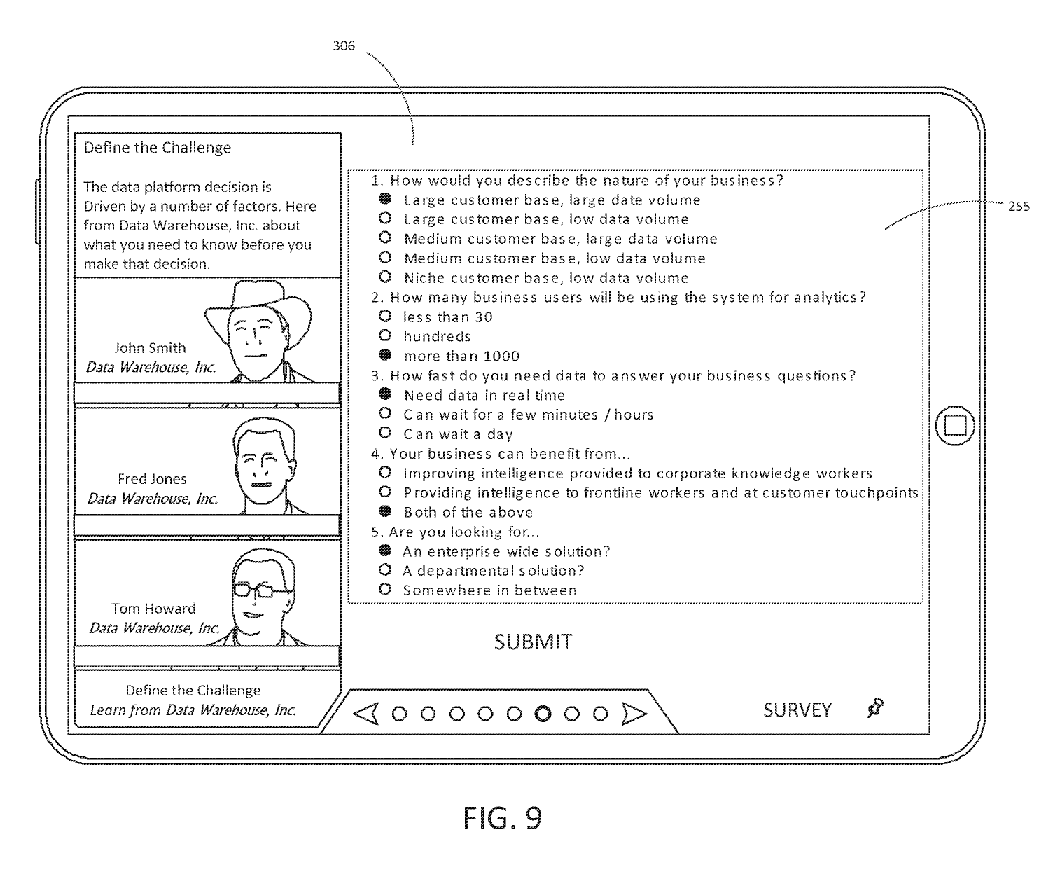

FIGS. 8 to 9 illustrate a preferred embodiment wherein a survey 255 is embedded within the presentation. In this case, the survey 255 is presented relatively near the end of the presentation. The survey 255 can be customized to specific user demographics, so that different users see a different survey 255. As shown, a product matrix 260 is presented illustrating the category of products offered, wherein the X-axis represents the usage scope from “departmental” to “enterprise”, and the Y-axis represents the complexity from “simple” to complex. Once the user completes the survey 255, the results are used to determine the quadrant of the product matrix 260 representing a product type. As illustrated, the product type “Extreme Performance Product” is shown in the “departmental-complex” quadrant of the product matrix 260.

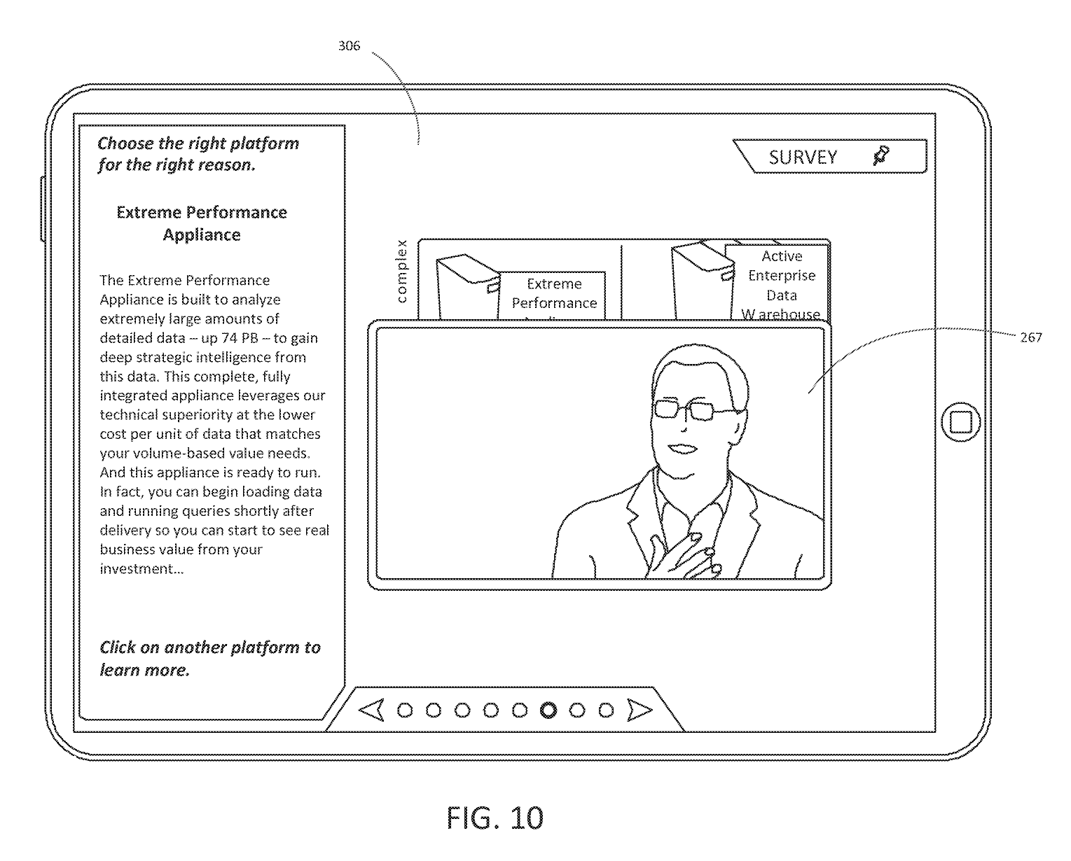

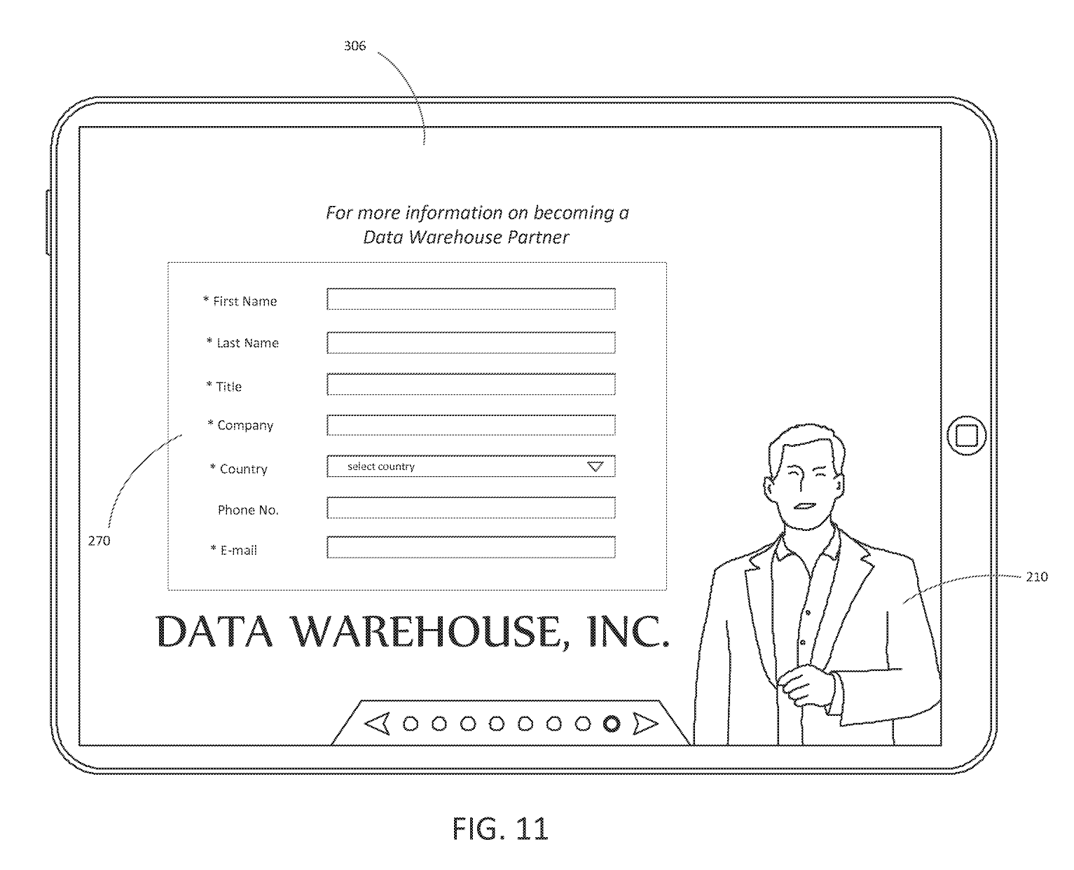

FIG. 10 shows a sales pitch for the “Extreme Performance Product” including a video snippet 267 and accompanying sales text 265 presenting a persuasive argument regarding purchase of this product. Finally, the threads converge to a single node, where the coach 210 encourages users to input contact information 270, in return for a white paper and custom report, as illustrated in FIG. 11. The contact information 270 can then be passed to the sales force as a qualified lead.

### ADDITIONAL EXAMPLES

Retail Store Sales Tool for Selection of Eyeglass Frames

In this example, we discuss an implementation of a retail store sales tool for selection of eyeglass frames. Potential users of the sales tool include (1) customers interested in purchasing new eyeglass frames, and (2) sales associates in the store. Both the customers and the sales associates may use the application via the Internet or a tablet computer. The challenge is that a typical eyeglass store has more than one thousand frames, but given a customer's eye prescription, face type, price sensitivity, and fashion preference, etc., only a small subset of frames will actually “fit” a particular customer. In this example, for the customer using the sales tool, the inputs would include the customer's gender, prescription data, and insurance information (if any), which could be retrieved from a customer database (or directly obtained from the user). Additionally, a survey could be used to have the customer select their “lifestyle preference” (active, professional, etc). Furthermore, a digital camera could take a photograph of the customer's face so as to determine the customer's face type. A customer's face type can be determined via analysis of the photograph—an oval shape is matched to the face with length positioned from the tip of the chin to top of the head and width from ear to ear. The ratio of the length of the oval to the width of the oval defines a face type index. An index >1 indicates a long oval face, an index closer to 1 a round face. Based on this face index and eye position relative to the oval, the dynamic thread generator 120 can provide expert fashion advice assembled from the content database 140 and select frames that are a best match to a particular face type.

As an example of one possible presentation thread 110, the rules 125 could narrow the frame sections to approximately 20 possibilities based upon the prescription data, gender, and face type, wherein the frame information is dynamically retrieved from a product database and images of the frames displayed on a virtual mirror where the customer can simulate trying on the suggested frames over their captured face video. For example, given the following three data elements—bi-focal prescription, female, round face type—an SQL query of the product database might would return a subset of approximately 20 frames that would most likely match the customer.

At the next node in the presentation thread 110, a survey could obtain lifestyle preference so that at the next thread node the user would see related expert videos. For example, a customer indicating interest in fashion might see a celebrity fashion guru describing his or her frame selection choices, an active lifestyle person may see a professional athlete discussing why he or she wears specific glasses and lenses, etc. Furthermore, coated lenses are significantly higher profitability, so that the testimonials could further include up-sell of these products. At another next node in the presentation thread 110, simulations could be presented to show how a polarized lens enables users to see more vivid color than non-coated. Finally, the user's insurance data could be used to help show four or five frame options for different levels of co-payments, and the presentation threads 110 could converge at an online checkout. Throughout the presentation thread 110, a coach 210 guides the journey, with customized appearance and dialogue at each thread node.

The sales associate presentation thread 110 would be different, but would have some of the identical presentation snippets assembled from the content database 140. For example, the sales associate could use the tool to learn about fashion advice and how to simplify the buying decision for customers, accessing identical video and simulation content as the customer. However, the sales associate thread might also include additional video snippets from senior sales managers to help sales associates overcome customer objections, and through simulations of customer interactions show better approaches to cross-sell and up-sell high margin products.

Learning Tool

In this example, we show how the invention is applicable to learning subjects, such as art appreciation, marketing, technology management, finance, engineering, fashion and design, etc. For example, if the topic were heart surgery, users could be surgeons, anesthesiologists, medical students, interns, nurses, insurance or compliance administrators, and so forth. The content database 140 would include heart simulations, video from expert surgeons describing proper surgical techniques and procedures. As different users interact with the system, custom threads would be generated so that the surgeon might learn the latest open-heart techniques from video snippets of world-renowned experts, in conjunction with heart simulations. A different audience, the surgical nurse, for example, would view some of the same content as the surgeon from the content data base 140, but might also see video snippets of expert nurses assisting surgeons, along with simulations on optimizing work flow in an operating room. A virtual coach would be assigned with customized content to the different users.

If the subject was finance, for example, the users might be senior finance executives, MBA students, compliance managers, and so forth. The content database 140 would include media files containing expert advice on various financial subjects from chief financial officers, compliance officers, tax experts, and the like. Thus, the respective media libraries would contain video snippets of experts presenting information, simulations, and other content relevant to each respective audience, and the dynamic thread generator 120 would generate a customized presentation thread 110 for the respective audience, as they interact with the system.

In these examples, surveys can be used to gather information useful for dynamically customizing the presentation thread 110 for specific users. To that end, the content database 140 can contain a library of survey templates. In an embodiment, the surveys can be used to measure knowledge transfer as participants traverse their presentation thread 110, and the thread can be changed dynamically to reinforce concept knowledge that measures below a pre-defined threshold.

Virtual Golf School

In this example, a user having a smart phone equipped with a built-in gyroscope and accelerometer (such as the Apple iPhone) uses the device to practice golf swings. At the beginning of the presentation thread 110, the user is asked to swing the smart phone as if it were a golf club. While “swinging” the smart phone, motion data is captured by the gyroscope/accelerometer useful in determining the swing path, the point of ball “impact”, and the instantaneous velocity at the point of impact. The pitch/roll/yaw of the imaginary golf club relative to an axis representing the club head can also be determined. Video and simulation snippets are then selected from the content database 140 and presented to the user, including video recordings of an expert golf instructor, who may be male or female, depending on the gender of the user (as determined from available demographics data). If it was determined that the user sliced the golf ball (curved the ball right of the target), the user might be presented with a video and simulation snippets on how to correct the slice. At the next thread node the user could be prompted to try an exercise with their device in hand to correct the slice, and customized audio output such as “hook”, “slice”, “straight”, and so forth, would be audibly outputted, as appropriate. In this example, the expert golf instructor would also be the virtual coach throughout.

This example also demonstrates an additional aspect of the invention, namely, outputs presented using multiple and discretely different devices, connected simultaneously via a network. For instance, as the user swings his or her smart phone, a golf ball simulation showing the flight of the ball along with video of an expert golf instructor offers advice are presented. In an embodiment, as the user swings the smart phone, the golf ball flight simulation is presented on a first device (e.g., a desktop computer, Web-enabled TV, or a tablet computer) while the video of the instructor offering the advice appears on a second device (e.g., the smart phone).

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A system, comprising:
an input device;
a content database;
a presentation thread generator; and
an output device;
wherein the presentation thread generator is configured to create a presentation thread, the presentation thread including a sequence of ordered nodes, each including at least one presentation snippet assembled using content elements selected from the content database, the selection and the assembly based at least in part on inputs received using the input device during traversal of the presentation thread and application of at least one rule; and
wherein the created presentation thread is outputted by the output device.

2. The system of claim 1, wherein the input device includes a touch screen.

3. The system of claim 2, wherein the presentation thread is created and outputted using one of a tablet computer and a smart phone.

4. The system of claim 1, wherein the presentation thread is outputted on two or more separate devices simultaneously.

5. The system of claim 1, wherein the created presentation thread includes interspersed therewith selected presentation snippets showing a coach.

6. The system of claim 1, wherein the content includes content in the form of one or more of text, video, and audio.

7. The system of claim 6, wherein the video content includes video of an expert.

8. The system of claim 6, wherein the content includes a testimonial.

9. The system of claim 6, wherein the content includes a simulation.

10. The system of claim 1, wherein the at least one rule includes selecting the content elements from the content database and assembling the presentation snippet based on a user's role in an organization or an industry.

11. The system of claim 1, wherein the presentation thread is directed to one of a sales presentation, information on how to use a product or service, information on how to select a product or service, information on learning how to play a sport, and information on learning a subject.

12. The system of claim 1, wherein at least one of the presentation snippets includes a test to measure learning.

13. The system of claim 12, wherein the result of the test is used, at least in part, to select the content for, and assembly of, next nodes.

14. The system of claim 1, wherein the inputs received from the input device include sensor data from at least one of a gyroscope and an accelerometer.

15. A system, comprising:
a plurality of client computing devices, each of the client computing devices communicatively coupled via a network to a server; and
the server configured to generate a plurality of presentation threads for each of the client computing devices, wherein each such presentation thread includes a sequence of ordered nodes, each node including at least one presentation snippet assembled using content element selected from a content database, the selection and the assembly based at least in part on inputs received from a respective input device during traversal of the presentation thread and application of at least one rule.

16. The system of claim 15, wherein the client computing devices include at least one each of: a tablet computer, a smart phone, a laptop computer, and a desktop computer.

17. The system of claim 15, wherein at least one of the presentation threads is outputted on two or more separate client devices simultaneously.

18. The system of claim 15, wherein the received inputs include motion information from a gyroscope and an accelerometer, and the presentation thread is output on two or more of a smart phone, a personal computer, a tablet computer, and a Web-enabled television.

19. The system of claim 15, wherein the presentation threads for a first participant and a second participant intersect, and at the intersection, the presentation snippets for the first participant and the second participant are the same, but other of the presentation snippets for the first participant and the second participant are different.

20. The system of claim 15 where the presentation thread is customized based upon the resolution of an output device display.
